(19) United States
(12) Patent Application Publication
(10) Pub. No.: US 2006/0271216 A1
(43) Pub. Date: Nov. 30, 2006

(54) Short-range wireless communication system for manufacturing production line

(76) Inventors: In-Shik Shim, Cheonan-si (KR); Min-Woo Yang, Gwacheon-si (KR); Gi-Cheon Yoon, Seongnam-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/445,093

(22) Filed: May 31, 2006

(30) Foreign Application Priority Data
May 31, 2005 (KR) 10-2005-0046063

(51) Int. Cl. G06F 19/00

(52) U.S. Cl. 700/95; 340/635

(57) ABSTRACT

In a production line for automatically conducting a process of manufacturing semiconductors or TFT-LCDs, short-range wireless (SRW) terminals are given to the workers arranged at the respective facilities to effect a signal transmission in accordance with a SRW communication protocol, and SRW access points are arranged at predetermined locations in the production line. The respective SRW terminals are connected to a central control server through the SRW access points at the relevant areas, and the call switching with respect to a plurality of other terminals is given thereto through the central control server. When a facility abnormality is detected, the occurrence of the abnormality is notified to the SRW terminal of the person in charge to speedily cope with the abnormality. A handover is selectively made between the SRW access points such that the worker continuously holds the communication using the SRW terminal even while moving. Accordingly, with the production line for automatically performing the process of manufacturing semiconductors or TFT-LCDs, the reciprocal communication and work cooperation between the workers are fluently made using the local area SRW communication technology.

This application claims priority to Korean Patent Application No. 2005-0046063, filed on May 31, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a SRW communication system and a method of operating the system, and in particular, to a short-range wireless (SRW) communication system in a production line for automatically performing a manufacturing process including a manufacturing process for semiconductors or thin film transistor liquid crystal displays (referred to hereinafter as “TFT-LCDs”).

(b) Description of the Related Art

The TFT-LCD manufacturing process has recently been automated so as to increase production efficiency. For instance, various processing steps of doping, diffusing, thermal oxidizing, chemical vapor depositing, etching, light-exposing, etc., are conducted within the respective facilities located along the production line an a step-by-step manner. When it can be intended to conduct the work in a specific facility separately, a cassette mounting the workpieces (such as wafers or glass) to be processed therein can be transferred to that facility by an automatic guided vehicle (“AGV”), and loaded to the facility such that the desired work can be automatically conducted. A plurality of workpieces mounted in the cassette are processed through several facilities such as a tester, a repairer, a cleaner, an oven, and a sealer, thereby completing TFT-LCDs. The respective facilities are connected to a host via facility servers connected thereto, and are controlled such that the relevant process related thereto can be automatically conducted.

Meanwhile, in order to make the process automation fluent, workers are placed at the respective facilities to manage the process. However, a typical semiconductors or LCDs production line may encompass an area can be so large that the workers may not be able to communicate well enough with each other to fluently cooperate in workpiece production. A manufacturing process that hinders fluent cooperation can be at risk for deleterious productions conditions, such as a manufacturing system shut-down. Undesirably, when all or part of a manufacturing system fails, processed materials undergoing fabrication, including wafers or glass, may be irreparably damaged, or the relevant facilities may become damaged so that the resulting production interruption generates can be an enormous economic loss and a costly deterioration of overall production yield. Furthermore, when a production line failure occurs, it may be difficult to manage an orderly departure of production line workers.

In an attempt to offset such problems, it may be desirable to install at the respective facilities a production line worker communication interface, such as a display device, e.g., a monitor, or an input and output device, e.g., a device bearing a speaker and a microphone, such that the workers can communicate with each other through such a production line worker communication interface device. However, when such devices are fixed to the facility, the worker may communicate only in predetermined areas, and thereby hindering fluent reciprocal communication and efficient work cooperation.

### SUMMARY OF THE INVENTION

A short-range wireless (SRW) communication system is provided that fluently effects reciprocal communication and work cooperation between workers in a manufacturing production line for facilitating a semiconductor or TFT-LCD manufacturing process, and that safely and speedily performs the relevant processing steps based on fluent and simultaneous communication among relevant workers. Present embodiments provide a SRW communication system that can speedily issue notification of a facility abnormality in the production line to effect correction. According to another embodiment, a SRW communication system can be provided in a production line for automatically conducting the process of manufacturing semiconductors or TFT-LCDs. According to one present aspect, a SRW communication system can be connected to a plurality of SRW access points arranged at predetermined locations in the production line. The SRW access points can communicate with a plurality of SRW terminals given to the respective workers in accordance with a SRW communication protocol to effect a signal transmission with each other. The SRW communication system includes a worker database for storing worker-related information containing at least one of identification numbers assigned to a plurality of groups of workers in the production line, information of the workers belonging to the respective groups, identification numbers of the terminals of the respective workers, and locations of the workers. The SRW communication system may further include an access point database for storing point-related information with at least one of locations of the access points installed within the production line and communication radii of the respective access points, and a call switching unit for conducting call switching between the SRW terminal of a first worker of at least one first group and the SRW terminal of a second worker of at least one second group.

According to another present embodiment, a SRW communication system can be connected to facility controllers installed at the respective facilities in the production line and to a plurality of SRW access points arranged at predetermined locations in the production line. The SRW access points communicate with a plurality of SRW terminals given to the respective workers in accordance with a SRW communication protocol to effect a signal transmission with each other. In this case, the SRW communication system may include a warning message database for storing warning messages per the respective warning codes at the respective facilities, a warning processor for transmitting a warning message to the SRW access point under the application of a warning notification request such that the warning message can be transmitted to the relevant SRW terminal, a warning database for storing information of persons in charge per the respective warning codes at the respective facilities, and a warning unit for receiving information of a facility abnormality from a facility controller containing the facility identification number and the warning code for the error, extracting information of the person in charge from the warning database based on the warning code, and requesting the warning notification while transmitting the warning code and the information of the person in charge. The warning processor transmits a warning message corresponding to the warning code to the SRW terminal of the person in charge that can be identified based on the information transmitted from the warning unit to notify the facility abnormality thereto.

According to another embodiment, a method of effecting call switching using a SRW communication system can be performed in a manufacturing production line for automatically conducting the manufacturing process for semiconductors or TFT-LCDs. The SRW communication system can be connected to a plurality of SRW access points arranged at predetermined locations in the production line. The SRW access points communicate with a plurality of SRW terminals given to the respective workers in accordance with a SRW communication protocol to effect a signal transmission with each other.

In this case, the method of effecting call switching using the SRW communication system includes the steps of: (a) transmitting an interrogation message for the targets to be switched to a first SRW access point from the system when the call switching can be requested from the SRW terminal of a first worker of a first group through the first SRW access point; (b) searching for the identification number of the SRW terminal of a second worker of at least one second group with the system when the switching target information of the second worker of the second group can be transmitted through the first SRW access point; (c) searching for the second SRW access point corresponding to the location of the SRW terminal of the second worker of the second group with the system, and requesting the call switching to the second SRW access point while transmitting the identification number thereto; and (d) forming at least one communication channel through the first and the second SRW access points with the system when the response signal to the call switching can be transmitted through the second SRW access point such that the communication between the SRW terminal of the first worker of the first group and the SRW terminal of the second worker of the second group can be effected.

According to still another embodiment, a method of notifying of an abnormality of a facility with a SRW communication system can be performed in a production line for automatically conducting the process of manufacturing semiconductors or TFT-LCDs. The SRW communication system can be connected to facility controllers installed at the respective facilities in the production line and to a plurality of SRW access points arranged at predetermined locations in the production line. The SRW access points communicate with a plurality of SRW terminals given to the respective workers in accordance with a SRW communication protocol to effect a signal transmission with each other.

In this case, the method of notifying of the abnormality of a facility with the SRW communication system includes the steps of: (a) upon receipt of facility abnormality information from any of the facility controllers with a warning code for the generated error and a facility identification information, extracting the person in charge that can be capable of coping with the warning code from the warning database storing the persons in charge per the respective warning codes of the facilities; (b) identifying the location of the terminal of the extracted person in charge; and (c) transmitting a warning message corresponding to the warning code to the SRW access point where the terminal of the person in charge is located, and to the terminal of the person in charge.

### BRIEF DESCRIPTION OF THE DRAWINGS

The present invention will become more apparent by describing embodiments thereof in detail with reference to the accompanying drawings, in which:

FIG. 1 can be a block diagram of a short-range wireless (SRW) communication system in a manufacturing production line, according to an embodiment of the present invention;

FIG. 2 is a diagram exemplifying the SRW communication system shown in FIG. 1;

FIG. 3 is a structural diagram of a SRW access point according to an embodiment of the present invention;

FIG. 4 is a structural diagram of a SRW terminal according to an embodiment of the present invention;

FIG. 5 is a structural diagram of a central server and a management server according to an embodiment of the present invention;

FIG. 6 is a flow diagram illustrating a call switching process with a SRW communication system according to an embodiment of the present invention;

FIG. 7 is a diagram exemplifying a 1:N communication based on the call switching process shown in FIG. 6;

FIG. 8 is a diagram exemplifying an N:N communication based on the call switching process shown in FIG. 6;

FIG. 9 is a diagram exemplifying the connection relationship between the respective devices with the notification of managers based on the call switching process shown in FIG. 6;

FIG. 10 is a flow diagram illustrating the hand-over process with a SRW communication system according to an embodiment of the present invention;

FIG. 11 is a flow diagram illustrating the location identifying process with a SRW communication system according to an embodiment of the present invention;

FIG. 12 is a structural diagram of a warning server for notifying of the occurrence of a facility abnormality with a SRW communication system according to another embodiment of the present invention;

FIG. 13 is a flow diagram illustrating the process of notifying of the occurrence of a facility abnormality with a SRW communication system according to another embodiment of the present invention; and

FIG. 14 is a diagram exemplifying the notification of the facility abnormality shown in FIG. 13.

### DETAILED DESCRIPTION OF PREFERRED EMBODIMENTS

Provided herein are apparatus and methods for a short-range wireless (SRW) communication system configured to effect fluent reciprocal communication and work cooperation among workers and proxies in a production line that implements an automated manufacturing process, including at least one of a semiconductor manufacturing process and a TFT-LCD manufacturing process. As used herein, the term short-range wireless technology (SRW) can include apparatus and methods that provide SRW communication and networking functionality at a range of from up to about 10 meters, to up to about 100 meters. An exemplary SRW technology can include technology operable according to the families of wireless technology specifications including without limitation BLUETOOTH® wireless technology specifications, IEEE 802.15 wireless technology specifications, and similar specifications supporting short-range, near-field, and wireless personal area (WPAN) communication and networking. BLUETOOTH® can be a registered U.S. trademark of the BLUETOOTH® Special Interest Group, Inc., Bellevue, Wash., USA. A proxy can be an semi-autonomous or autonomous production line apparatus, for example, a robotic apparatus, capable of communicating with human production line workers using SRW apparatus and methods. SRW apparatus can include, without limitations, one or more of a wireless access point, a wireless terminal, a display, an interface, a sensor, an effector, a processor, a server, and a client that can be configured, disposed, or coupled to intercommunicate communicate, at least in part, using SRW methods. Selected embodiments of the SRW communication system herein can effect 1:1, 1:N, and N:N communications. An SRW communication system embodiment may be configured to wirelessly communicate text data, audio data, and video data within a local area of between about 10 m-100 m at a selected communication rate, e.g., 1 Mbps.

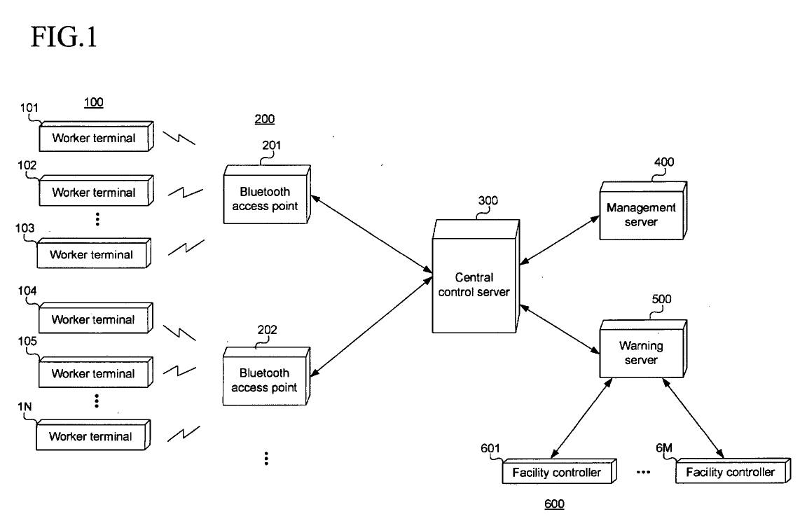

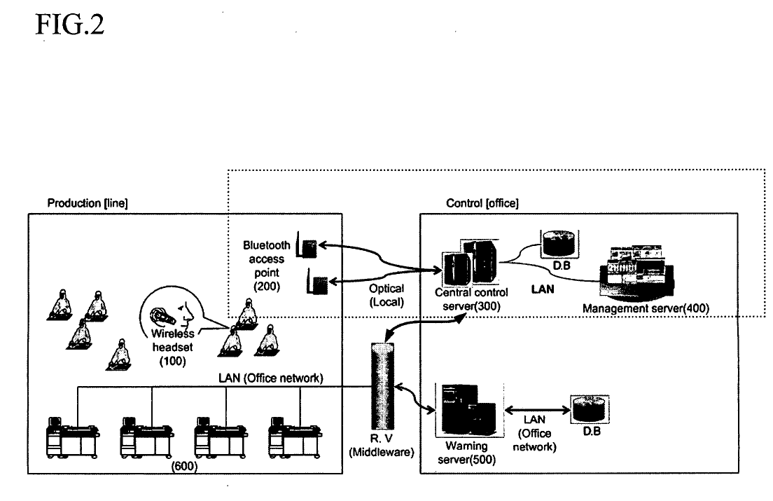

FIG. 1 is a block diagram of a SRW communication system in a production line according to a present embodiment (referred to hereinafter as the “SRW communication system”), in which a plurality of SRW terminals 101-1N may be provided to the respective workers within the production line (collectively indicated by 100 and called the “terminal,” for explanatory convenience) and SRW access points 201, 202, . . . (collectively indicated by 200 and called the “access point,” for explanatory convenience) are connected to each other via a first network (for example, a wireless network). Access point 200 can be connected to a central control server 300 via a second network (for example, a wire network). In addition, management server 400 may be connected to central control server 300 to register and manage the terminal, the access point, or both. Furthermore, a warning server 500 may be connected to the central control server 300, and in this case, the warning server 500 can be connected to facility controllers 601-6M (collectively indicated by 600, for explanatory convenience) installed at the respective facilities. With the above-structured SRW communication system, as exemplified in FIG. 2, the terminal 100 and the access point 200 are arranged in the production line, and the central control server 300, the management server 400, and the warning server 400 may be arranged in the control office.

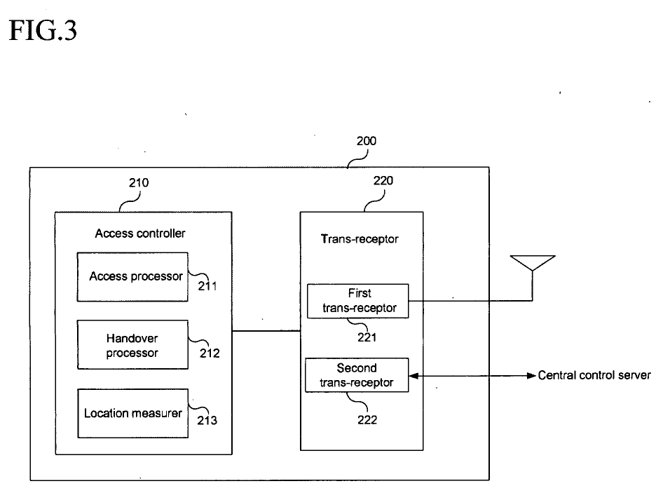

FIGS. 3 to 5 illustrate the specific structure of the respective structural components shown in FIG. 1. The SRW access points 200 relay the SRW communication for the terminals of a cell within a definite radius from a predetermined location, and particularly with the embodiment of the, conduct the mobility management with respect to the terminals. The mobility management can be divided into handover management and location management. With the location management, the locations of the terminals are continually identified and recorded even when they are not in communication but are in an idle state such that the communication service can be made whenever other workers want to communicate with the relevant terminal on the network. The handover effects a disconnection-free communication service when the terminal under communication moves and it can be necessary to shift the network contact point thereof. For this purpose, as shown in FIG. 3, the SRW access point 200 includes an access controller 210 and a transceiver 220. The access controller 210 includes an access processor 211 for effecting a signal trans-reception with the terminals in accordance with the SRW communication protocol, a handover processor 212 for effecting a handover in accordance with the movements of the terminals, and a location measurer 213 for measuring the locations of the terminals and reporting the measured location to the central control server 300. The transceiver 220 includes a first transceiver 221 for making a trans-reception with the terminal 100, and a second transceiver 222 for effecting the trans-reception with the central control server 300.

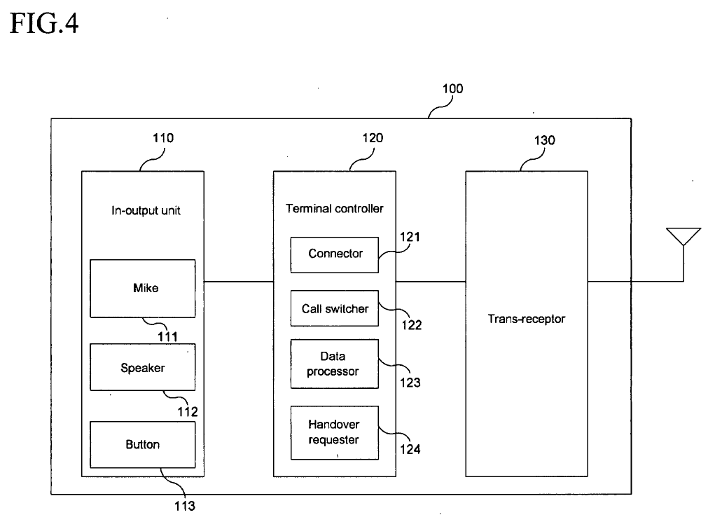

As shown in FIG. 4, the SRW terminal 100 that accesses the SRW access point and takes part in a SRW communication service includes an in-output unit 110, a terminal controller 120, and a transceiver 130. In addition, although not shown in the drawing, a display device may be further provided. The terminal controller 120 includes a connector 121 for connecting with the SRW access point, a call switcher 122 for processing the audio data and the trans-reception through the predetermined SRW access point, a data processor 123 for processing the data except for the audio data and controlling the trans-reception, and a handover requester 124 for requesting the handover. A handover can be made with the SRW communication system, for example, when a handover is requested from the side of the terminal. A handover may be effected by the access point, irrespective of the request of the terminal. In this case, the terminal 100 may omit the handover requester 124. The transceiver 130 conducts the signal trans-reception through the SRW access point, and the audio in-output unit 110 includes a microphone 111 for inputting the audio data, a speaker 112 for audio-outputting the data from the terminal controller, and a plurality of input buttons 113 with short key functions. For instance, a call button for transmitting the call switching request, and a response button for responding to the call switching request may be provided as the input buttons 113.

SRW terminal 100 may be formed in various shapes, and in this embodiment, it has the shape of a headset. It can be possible that a SRW terminal in the shape of a headset can be provided to the respective workers, and that a terminal with another shape (such as an IP telephone terminal) can be provided to the respective managers. It will be explained in relation to present embodiments that a wireless headset-shaped SRW terminal communicable according to a SRW technique can be provided to the respective workers, and an IP terminal capable of telephoning through a central control server can be provided to the respective managers.

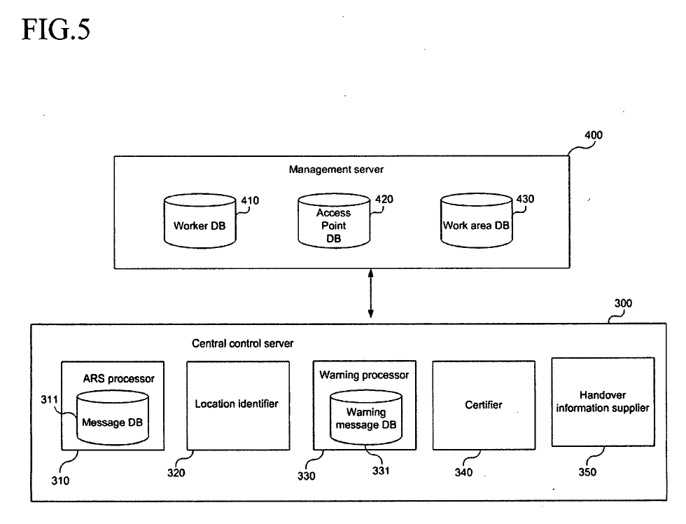

Meanwhile, the central control server 300 can control the SRW access point 200 and the terminal 100 such that the SRW communication between the terminals can be effected. For this purpose, as shown in FIG. 5, central control server 300 includes ARS processor 310 being the call switching unit for conducting the call switching between the SRW terminals, a location identifier 320 for identifying the locations of the workers based on the signals from the access points, and a warning processor 330 for notifying of the abnormality of the facility. Furthermore, central control server 300 includes certifier 340 for judging of the registration of the relevant terminals such that the communication between the registered terminals can be effected, and handover information supplier 350 for supplying the handover information to access points 200.

In order to automatically process the call switching, ARS processor 310 may include message database 311 for storing situational information messages. Warning processor 330 may also include warning message database 331 for storing warning messages pursuant to the abnormalities of the respective facilities (such as warning codes). Message database 311 may be realized independently of ARS processor 310.

In general, management server 400 registers and manages the SRW access points, the SRW terminals of the workers, and the IP terminals. Accordingly, the management server 400 can include a worker database 410 for storing much information obtained through the registration and management, an access point database 420, and a work area database 430. The worker database 410 classifies the workers in the production line into a plurality of groups, and stores the group identification numbers assigned to the respective groups, the information of the workers belonging to those groups, the terminal identification numbers of the respective workers, and the work areas of the workers. Other indicia pertinent to the production operation also may be stored in and managed by database 410. Various indicators that are capable of identifying the groups such as a number and a name may be used as the group identification numbers. In access point database 420 can be stored information concerning production line access points, such as the installation locations of the access points and the communication radius of the relevant access point. The work area database 430 can store the identification information of the worker terminals corresponding to the identification information of the SRW access points relevant to the work areas of the workers. The information stored in the work area database 430 can be used in judging of the departure of the worker from the work area.

The structural components of the respective devices are classified depending upon the functions thereof, but they are not limited thereto. An operation of a SRW communication system in a production line according to present embodiments will now be explained based on the above-described structure. The SRW terminals assigned to the respective workers in the line first attempt to access the SRW access point 200 at the relevant area in accordance with the user request, or irrespective thereof. The connector 121 of the SRW terminal 100 performs an inquiry process for receiving a packet containing a predetermined operation frequency sent from the SRW access point 200 corresponding to the location of the relevant terminal. The access processor 211 of the SRW access point 200 broadcasts an inquiry using an ID packet for a predetermined period of time to detect a terminal that can be newly introduced into the communication area thereof. The ID packet contains an operation frequency to tune the operation clocks and frequencies of the SRW facilities to each other.

Upon receipt of the ID packet containing an operation frequency from the SRW access point 200, the connector 121 of the terminal controller 120 can perform an inquiry scan process synchronized with the operation frequency contained in the received packet, and can transmit the packet containing the clock information thereof to the SRW access point 200. The access processor 221 of the SRW access point 200 can perform a page process for transmitting the control packet for clock synchronization to the terminal 100. When the connector 121 of the terminal 100 is clock-synchronized in accordance with the control packet and performs the page scan process for transmitting the response packet thereto, a link capable of transmitting and receiving a signal can be formed between the terminal 100 and the access point 200. As described above, the process of accessing the access point with an inquiry, an inquiry scan, a page, and a page scan can be performed in a cyclic way, pursuant to the user request, or at a predetermined time so that a link may be formed between the SRW terminal 100 and the SRW access point 200. With the link for communication, the call switching service given to the SRW terminals assigned to the workers will be now explained. Only a method of interconnecting a plurality of workers using SRW terminals will now be explained.

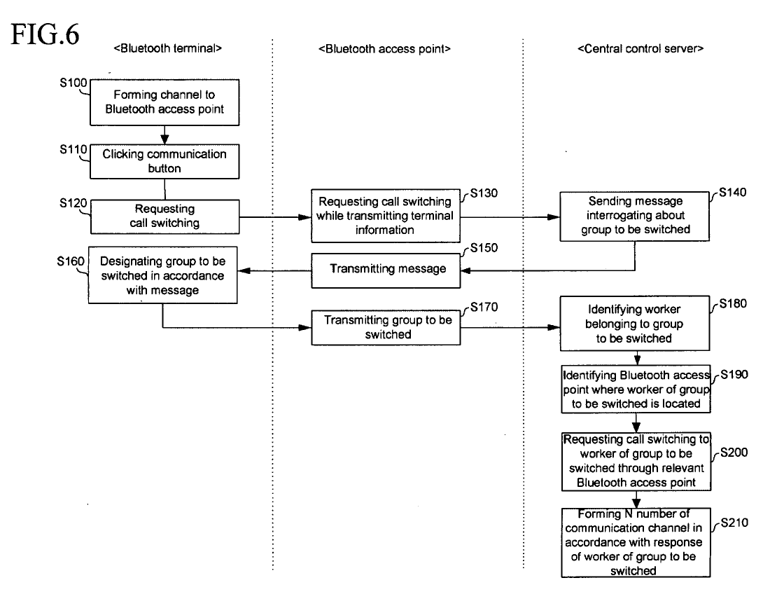

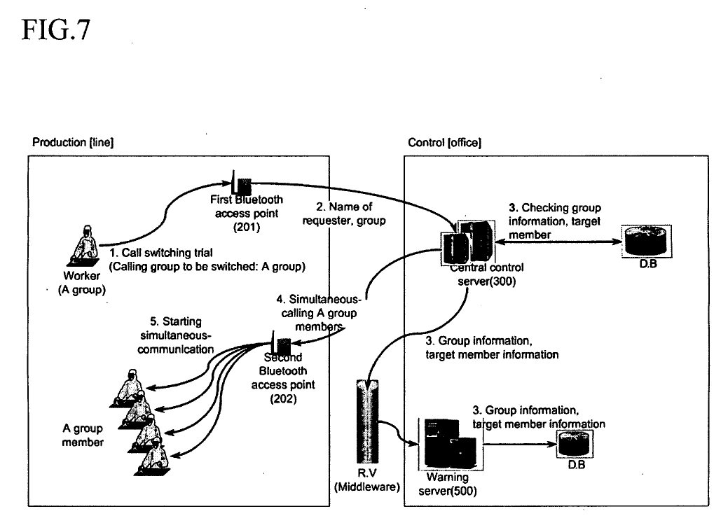

FIG. 6 sequentially illustrates an embodiment of a call switching process, and FIG. 7 illustrates an information flow during the call switching process illustrated in FIG. 6. When a first worker belonging to a first group wants to communicate with workers belonging to a second group to request work cooperation, a predetermined short key such as a call button formed at the SRW terminal of the first worker (for explanatory convenience, the terminal of the first worker is indicated by 101) can be used, and the call switcher 122 of the terminal controller 120 transmits the call switching request signal to the linked SRW access point 200 through the transceiver 130 (S100-S120). Upon receipt of the call switching request signal, the SRW access point 200 requests the call switching to the ARS processor 310 of the central control server 300 (S130). The data from the ARS processor 310 are transmitted to the SRW terminal 101 so that the signal trans-reception can be made between the terminal 101 and the ARS processor 310 of the central control server 300.

Upon receipt of the call switching request, the ARS processor 310 transmits signals containing automatic information messages interrogating about the switching targets to the terminal 101 via the access point 200 (S140-S150). The call switcher 122 of the terminal controller 120 processes the automatic information messages contained in the received signals, and outputs them through a speaker 112. For instance, an information comment can be output, such as “Speak the name of the group to be switched.” Accordingly, when the first worker speaks the identification number of the second group to be switched, the relevant audio data are processed by the call switcher 122 and transmitted to the ARS processor 310 via the access point 200 (S160-S170). The ARS processor 310 searches for the information of second workers belonging to the second group to be switched (such as the terminal identification number), and attempts to effect the call switching to the terminals of the second workers of the second group (for explanatory convenience, the terminals of the second workers of the second group are collectively indicated by 102 (S180).

In this case, the ARS processor 310 can send the identification information of the terminals 102 of the second workers to the SRW access points 200 at the area corresponding to the locations of the second workers of the second group to request the call switching. However, if any of the second workers depart from the proper work area and leave the communication radius of the relevant SRW access point 200, the call switching through that SRW access point 200 cannot be made. In order to prevent such a case, the ARS processor 310 identifies the locations of the second workers of the second group to be switched based on the information identified by the location identifier 330, and finds the communicable SRW access points at the current locations of the second workers, followed by requesting the call switching to those SRW access points (S190). When the call switching request signals from the SRW access points are transmitted to the terminals 102 of the second workers of the second group, the call switcher 122 of the respective terminals 102 informs of the call switching request through the speaker 112. When the second workers of the second group click the response button to respond to the call switching request, the call switchers 122 of the terminals 102 transmit the response signal to the central control server 300 through the SRW access points 200 so that communication channels are effected between the terminal 101 of the first worker and the terminals 102 of the second workers of the second group (S200-S210). In this way, the 1:N communication between the first worker and the workers of the second group can be made through the plurality of communication channels shown in FIG. 7.

With the step of designating the group to be switched, the first worker may select and designate only particular workers from the group to be switched. That is, instead of designating all the workers of the second group, only some particulars of the second workers of the second group can be designated. Even in this case, the first worker sequentially designates the second group and selects the particular second workers of the second group based on the information message received through the ARS processor 310 of the central control server 300. Thereafter, the ARS processor 310 makes the call switching request only to the terminals of the selected second workers.

The first and second groups are divided for explanatory convenience to represent the communication between different workers, and may be identical with each other or different from each other. In the case that the first and second groups are identical with each other, the workers belonging to one group intend to communicate with other workers of that group. In this case, with the S180 step, the ARS processor 310 selects the workers belonging to the same group except for the first worker, and makes the call switching request to those workers in the way described above.

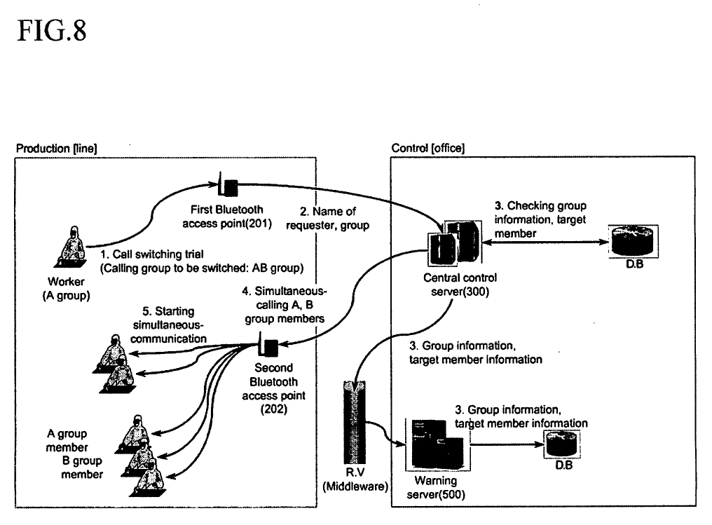

Furthermore, an N:N communication between a plurality of workers and another plurality of workers may be made. The information flow with an N:N call switching process embodiment is exemplified in FIG. 8. The process of making the N:N communication can be performed similarly to the aforementioned 1-N communication process except for the steps of designating the target workers to be switched, and identifying the terminals of those targets. That is, if ARS processor 310 interrogates about the targets to be switched in accordance with the call switching request, the first worker of the first group may designate the first group together with another second group. The ARS processor 310 of the central control server 300 detects the terminal information of the workers belonging to the designated first and second groups from the worker database 410, and simultaneously transmits the call switching request signals to the detected terminals. Upon receipt of the call switching request signals, the workers of the respective groups respond thereto, and communication channels are formed between the workers of the first and the second groups, thereby making the N:N communication.

Meanwhile, with the call switching request, the central control server 300 may certify the terminal requesting the call switching such that the call switching service can be given to the registered terminal. In this case, a certifier 340 of the central control server 300 judges whether the identification number can be registered at the worker database 410 in accordance with the call switching request signals containing the identification number of the terminal transmitted from the SRW access point 200. When it can be registered, the automatic call switching can be made by the ARS processor 310, while when it cannot be registered, information data representing the impossibility of the call switching are transmitted. In addition, a 1:1 communication may be made between the workers. With the call switching according to a present embodiment, the central control server 300 may process the call switching using the process type of multiple processing and the VRS-based P2P together, and further, it effects the 1:N and N:N call switching in the way of a thread so as to minimize system load and data loss.

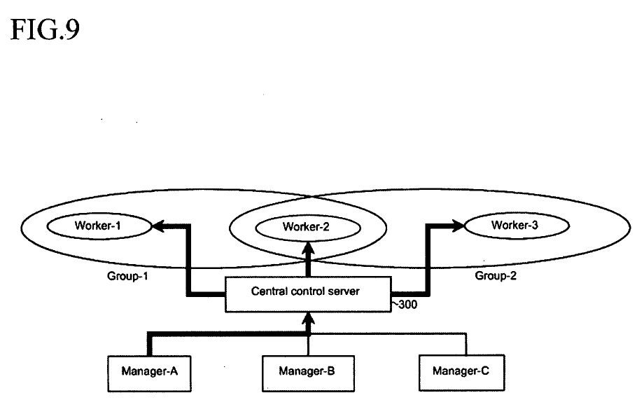

As described above, the call switching service may be given to the workers through the SRW terminals, and also between the manager and the workers. FIG. 9 exemplifies the interconnection of the respective devices when the notification process of the manager is conducted. When an IP terminal can be given to the manager instead of a wireless headset-shaped SRW terminal, the manager inputs a specific number representing the collective notification through the IP terminal. The ARS processor 310 of the central control server 300 transmits a message representing a predetermined notice to all the SRW terminals 100, which output the message through the speaker 112. The workers select the response buttons so that communication channels are effected between the terminals 100 and the IP terminal of the manager, and hence the notice of the manager can be transmitted to all the workers. In this case, instead of the collective notification, the manager may designate a specific group or specific workers, and notify the target message to the designated group or workers. Meanwhile, when the 1:N communication or N:N communication can be done through the above call switching process, any of the workers being the communicator may depart from the communication radius of the access point connected to the terminal. In this case, a handover can be performed between the relevant access points such that the communication state of the terminal can be not interrupted.

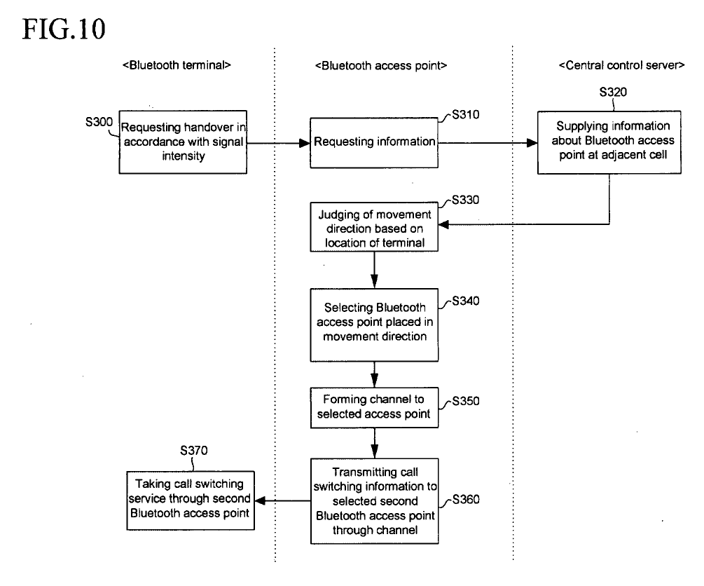

FIG. 10 sequentially illustrates a handover process embodiment for SRW terminals, in which the SRW access points conduct the handover in accordance with the handover request of the terminals. By contrast, the SRW access points may judge whether the handover should be conducted, and conduct the handover by themselves irrespective of the request of the terminals. As shown in FIG. 10, a handover requester 124 of the terminal 100 can continuously measure the intensity of the signals transmitted from the first SRW access point (for explanatory convenience, the first SRW access point is indicated by 201) to which the terminal 100 can be connected at the current location thereof, and can compare it with a predetermined reference value. When the signal intensity exceeds the predetermined value, it is judged to be communicable. By contrast, when the signal intensity is smaller than the predetermined value, it is judged to be non-communicable through the currently connected first SRW access point 201, and the handover can be requested to the first SRW access point 201 (S300). Upon receipt of the handover request signal from the terminal 100, the handover processor 212 of the first SRW access point 201 detects information about the SRW access points of the cells neighboring thereto through the central control server 300. The handover information supplier 350 of the central control server 300 finds information about other access points placed around the first SRW access point 201 from the access point database 420 in accordance with the information request, and transmits the found information to the first SRW access point 201 (S310-S320).

The handover processor 212 of the first SRW access point 201 selects one SRW access point for giving the communication service for the terminal 100 from the plurality of SRW access points neighboring thereto based on the received information. With the selection of the handover access point, the movement direction of the terminal may be in consideration. That is, the movement direction of the terminal can be detected, and the access point placed in that direction can be selected to make the handover. The SRW access point to make the handover may be selected in various other manners. It will be explained here that the SRW access point to make the handover can be selected in consideration of the movement direction of the terminal. The handover processor 212 judges in which direction the terminal moves based on the location of the terminal measured by the location measurer 213, and selects the SRW access point placed in the movement direction of the terminal to make the handover (S330-S340). The channel can be formed to the newly selected SRW access point, that is, to the second SRW access point (for explanatory convenience, the second SRW access point can be indicated by 202), and the existent call switching information can be transmitted thereto (S350-S360). The call switching information includes the identification information of the terminal of the worker requesting the call switching, and the identification information of the terminals of the targets to be switched.

In this way, the first SRW access point 201 determines the second SRW access point 202 to make the handover, and gives the information of the second SRW access point 202 to the terminal 100 such that the terminal 100 can have access to the second SRW access point 202. Thereafter, the terminal 100 conducts the process of inquiry, inquiry scan, page, and page scan with the second SRW access point 202, and can be tuned to the second SRW access point in clock and frequency. The terminal 100 can be then continuously given the call switching service through the second SRW access point 202 (S370). Consequently, the worker may continuously hold the communication even while moving. In the meantime, when the worker departs from the work area, the process may not be performed fluently. In this case, a warning message can be automatically transmitted to the departed worker such that he returns to the work area and proceeds with the required work.

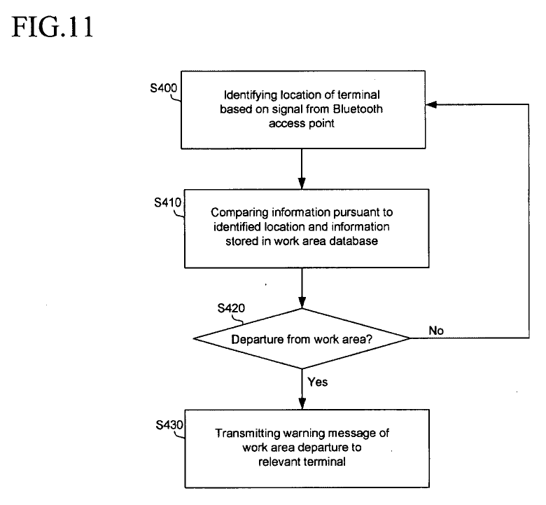

FIG. 11 illustrates a process embodiment of identifying the location of a worker. The location identifier 320 of the central control server 300 identifies the locations of the respective terminals based on the location measurement signals (including the terminal identification information and the access point identification information) transmitted from the SRW access points 200, which receives the signals transmitted from the terminals and reports them (S400). It can be judged whether the terminal identification information and the access point identification information contained in the location measurement signals conform to the registered information (S410-S420). That is, the terminal identification information of the respective workers for the work areas thereof and the access point identification information corresponding to those work areas are stored at the work area database 430 of the management server 400. Accordingly, if the access point where the terminal is presently located does not conform to the registered access point based on the location measurement signals, the location identifier 320 judges that the worker has departed from the work area, taking the terminal. When it is judged that the worker has departed from the work area, the location identification unit 320 notifies such a departure to the warning processor 330, and the warning processor 330 sends a warning message to the SRW access point 200 issuing the location measurement signals such that the message can be transmitted to the worker terminal 100 (S430). For example, the warning message may be “It has been determined that the worker has departed from the work area: please return to the proper work area.” Accordingly, the worker returns to the work area in accordance with the warning message from the central control server 300. In this way, the management of the workers may be effectively performed.

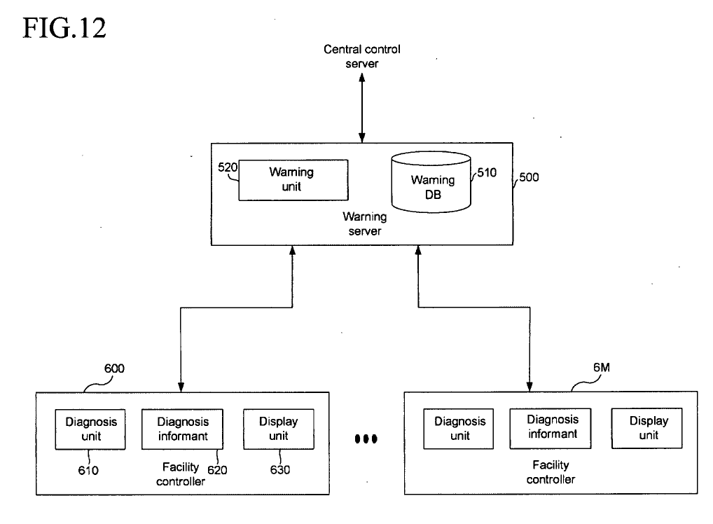

An embodiment of a method for issuing notification of an abnormality of a facility using a SRW communication system in the production line will now be explained. FIG. 12 illustrates the structure of a warning server embodiment for notifying of the occurrence of a facility abnormality with a SRW communication system. With the SRW communication system embodiment, as shown in FIG. 12, the warning server 500 can be connected to the facility controllers (600-6M, for explanatory convenience, collectively indicated by 600) installed at the respective facilities via a third network (such as LAN). In this case, as shown in FIG. 2, the warning server 500 may be connected to the respective facility controllers 600 via middleware. Meanwhile, the facility controller 600 can be installed at the respective facilities to control the operation of the relevant facility, and can diagnose the occurrence of an abnormality of the relevant facility to enable notification. For this purpose, as shown in FIG. 12, the facility controller 600 includes a diagnosis unit 610 for diagnosing the occurrence of a facility abnormality, and a diagnosis informant 620 for informing of the facility abnormality information to the warning server 500 when the facility abnormality can be diagnosed. The facility abnormality information may include warning codes representing the types of the facility abnormalities, and facility identification information. In addition, the facility controller 600 may include a display unit 630 for displaying the data from the central control server or the warning server, or the self-processed data. The warning server 500 judges whether the warning should be made in accordance with the warning code contained in the facility abnormality information transmitted from the facility controller 600, and when needed, requests the warning notification to the central control server 300. For this purpose, the warning server 500 includes a warning database 510 for storing various kinds of warning codes representing the possible abnormalities of the respective facilities and the notification necessity information for the respective warning codes, and a warning unit 520 for selectively requesting the warning notification to the central control server 300 based on the information stored in the warning database and the facility abnormality information from the respective facility controller.

In addition, the information about the person in charge of the facility abnormality for the respective warning codes (for example, an identification number of the person in charge or a terminal identification number assigned to the person in charge) can be stored in the warning database 510 such that the person in charge of the relevant facility abnormality can be directly called to solve the facility abnormality. The warning processor 330 of the central control server 300 notifies of the occurrence of warning to the person in charge, the worker of the abnormal facility, or to the terminal of the worker placed closest to the facility in accordance with the warning request from the warning server 500 based on the warning message database 331 storing the warning messages per the respective warning codes. The warning message database 331 can be not subject to the warning processor 330, but may be realized independently.

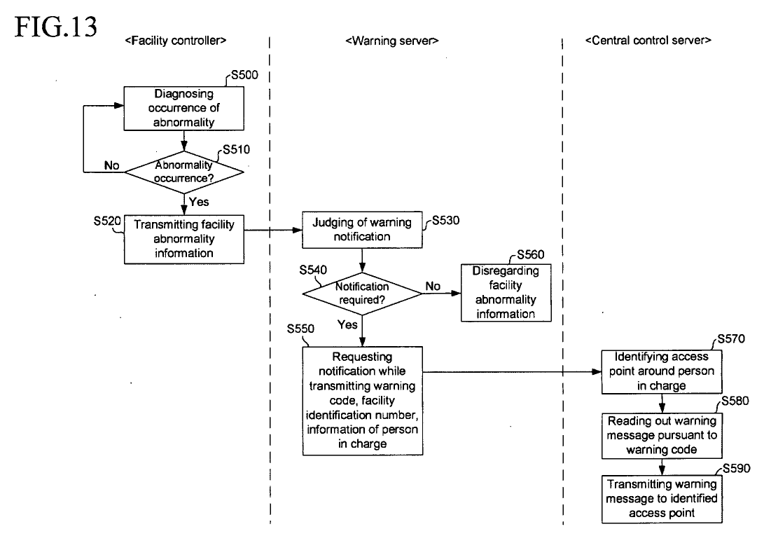

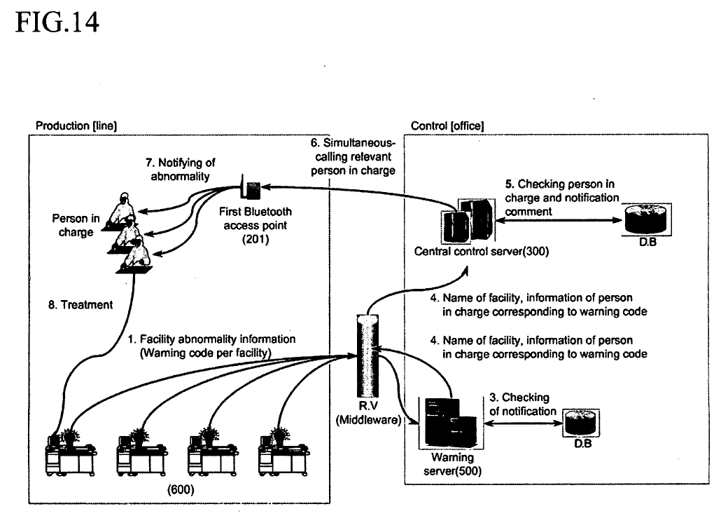

An embodiment of a method of notifying of the facility abnormality will now be explained. FIG. 13 illustrates an embodied process of notifying of the facility abnormality with a SRW communication system , and FIG. 14 illustrates the information flow during the process illustrated in FIG. 13. As shown in FIGS. 13 and 14, the diagnosis unit 610 of the facility controller 600 installed at the respective facilities diagnoses the abnormality of the relevant facility by a predetermined cycle or continuously, or at a predetermined time (S500). A method of diagnosing the facility abnormality may be based on the well-known techniques in the relevant automation field, and hence a detailed explanation thereof will be omitted. When the abnormality is found with the diagnosis, the diagnosis informant 620 notifies the warning code corresponding to the abnormality and the facility abnormality information containing the identification number of the relevant facility to the warning server 500 (S510-S520).

Upon receipt of the facility abnormality information, the warning unit 520 of the warning server 500 searches the warning database 510 based on the facility identification number and the warning code contained therein, and judges whether the facility abnormality should be warned (S530). When the warning is necessary, the information on the person in charge corresponding to the warning code can be extracted, and the information, the facility identification code, and the warning code are transmitted to the central control server 300 to request the warning notification (S540-S550). When the facility abnormality warning is not needed, the relevant information may be disregarded (S560).

Upon receipt of the warning notification request from the warning server 500, the warning processor 330 of the central control server 300 identifies the location of the facility where the relevant person in charge is located from the worker database 410 based on the received information, and detects the access point at the area of the relevant person from the access point database 420 based on the identified location (S570). Then, the relevant warning message is read out of the warning message database 331 based on the warning code (S580). The terminal identification number of the person in charge and the warning information message corresponding to the warning code are transmitted to the detected access point 200 (S590). Accordingly, as shown in FIG. 14, the warning message representing the facility abnormality can be transmitted to the person in charge such that the person speedily recognizes the occurrence of a facility abnormality to solve it. Meanwhile, as the person in charge may depart from the work area, in the step S570, the warning processor 330 identifies the current location of the person through the location identifier 320, and transmits the warning message to that person through the access point corresponding to the identified location.

Furthermore, in this case, the occurrence of a warning may be notified to the worker placed closest to the abnormal facility based on the location of the worker identified through the location identifier. That is, the worker placed closest to the abnormal facility can be extracted based on the identified worker locations, and the warning information message corresponding to the warning code can be transmitted to the terminal of that worker, thereby solving the abnormality speedily.

As described with the structure above, reciprocal communication and fluent work cooperation among workers can be effected using present SRW communication system embodiments in a manufacturing production line for automatically processing semiconductors or TFT-LCDs. Furthermore, handover can be effected between the access points supporting the local area SRW communication so that even when the worker moves, the required communication service can be continuously given to the worker without any interruptions. The work instruction can be notified to all the workers or many of the workers, and the fluent and simultaneous communication can be effected among all the members of the group for doing specific work so that the work can be completed safely and speedily. Furthermore, if the worker departs from the work area, the warning message can be speedily transmitted to the worker, thereby managing the workers effectively. In the case that any facility abnormality is found, it the person in charge can be speedily notified so that the damage due to the facility abnormality can be minimized. Those skilled in the art will appreciate that various modifications and substitutions can be made to presented embodiments without departing from the spirit and scope of the appended claims.

What is claimed is:

1. A short-range wireless communication system in a manufacturing production line for facilitating the manufacturing of semiconductors or TFT-LCDs, the SRW communication system being connected to a plurality of SRW access points arranged at predetermined locations in the production line, the SRW access points communicating with a plurality of SRW terminals given to the respective workers in accordance with a SRW communication protocol to effect signal transmission with each other, the SRW communication system comprising:
a worker database for storing worker-related information comprising at least one of identification numbers assigned to a plurality of groups of workers in the production line, information of workers belonging to the respective groups, identification numbers of the terminals of the respective workers, and locations of the workers;
an access point database for storing access point-related information comprising at least one of locations of the access points installed within the production line, and communication radii of the respective access points; and
a call switching unit for conducting the call switching between the SRW terminal of at least one first worker of a first group, and the SRW terminal of at least one second worker of a second group.

2. The SRW communication system of claim 1, wherein the call switching unit selects the relevant SRW access point from the access point database based on the location of the second worker identified from the worker database, and requests the call switching to the terminal of the second worker through the selected SRW access point.

3. The SRW communication system of claim 1, further comprising a location identifier for identifying locations of the workers based on the signals transmitted from terminals through the SRW access points.

4. The SRW communication system of claim 3, wherein the call switching unit selects the relevant SRW access point from the access point database based on the locations of the second worker identified from the location identifier, and requests the call switching to the terminal of the second worker through the selected SRW access point.

5. The SRW communication system of claim 3, further comprising a work area database for storing identification numbers of the terminals of the workers corresponding to the identification numbers of the SRW access points relevant to the work areas of the workers, wherein when the access point identification number and the terminal identification number contained in the measurement signals of the location of the terminal transmitted through the predetermined SRW access point do not agree with the information stored in the work area database, the location identifier judges that the worker of the terminal has departed from the work area, and transmits a message of work area departure to the relevant terminal.

6. A short-range wireless communication system (SRW) in a production line for automatically conducting the process of manufacturing semiconductors or TFT-LCDs, the SRW communication system being connected to facility controllers installed at the respective facilities in the production line and to a plurality of short-range wireless (SRW) access points arranged at predetermined locations in the production line, the SRW access points communicating with a plurality of SRW terminals given to the respective workers in accordance with a SRW communication protocol to effect a signal transmission with each other, the SRW communication system comprising:
a warning message database for storing warning messages for the respective warning codes at the respective facilities;
a warning processor for transmitting a warning message to the SRW access point under the application of a warning notification request such that the warning message is transmitted to the relevant SRW terminal;
a warning database for storing information of persons in charge for the respective warning codes and the respective facilities; and
a warning unit for receiving information of a facility abnormality from a facility controller containing the facility identification number and the warning code for the error, extracting information of the person in charge from the warning database based on the warning code, and requesting the warning notification while transmitting the warning code and the information of the person in charge,
wherein the warning processor transmits a warning message corresponding to the warning code to the SRW terminal of the person in charge that is identified based on the information transmitted from the warning unit to notify the facility abnormality thereto.

7. The SRW communication system of claim 6, further comprising a location identifier for identifying locations of the workers based on the signals of the terminals transmitted through the SRW access points, wherein the warning processor identifies the location of the person in charge based on the location of the terminal determined by the location identifier to find the access point corresponding to the identified location from the access point database, and transmits the warning message to the access point together with the terminal identification number to notify the facility abnormality thereto.

8. A method of effecting call switching using a short-range wireless communication system (SRW) communication system in a production line for automatically conducting the process of manufacturing semiconductors or TFT-LCDs, the SRW communication system being connected to a plurality of short-range wireless SRW access points arranged at predetermined locations in the production line, the SRW access points communicating with a plurality of SRW terminals given to the respective workers in accordance with a SRW communication protocol to effect a signal transmission with each other, the method comprising the steps of:
(a) transmitting an interrogation message for the targets to be switched to a first SRW access point from the system when the call switching is requested from the SRW terminal of a first worker of a first group through the first SRW access point;
(b) searching for the identification number of the SRW terminal of at least one second worker of a second group with the system when the switching target information of the second worker of the second group is transmitted through the first SRW access point;
(c) searching for the second SRW access point corresponding to the location of the SRW terminal of the second worker of the second group with the system, and requesting the call switching to the second SRW access point while transmitting the identification number thereto; and
(d) forming at least one communication channel through the first and second SRW access points by the system when the response signal to the call switching is transmitted through the second SRW access point such that the communication between the SRW terminal of the first worker of the first group and the SRW terminal of the second worker of the second group is effected.

9. The method of claim 8, wherein when the first worker designates two or more of the second workers of the second group at the (b) step, 1:N communication channels are formed between the first worker of the first group and the two or more of the second workers of the second group.

10. The method of claim 8, wherein as the first worker designates two or more of the second workers of two or more of the second groups at the (b) step, 1:N communication channels are formed between the first worker of the first group and the two or more of the second workers of the two or more of the second groups.

11. The method of claim 8, wherein with the (c) step, the system judges the locations of the second workers from the database storing the locations of the workers based on the SRW terminals of the second workers.

12. The method of claim 8, wherein with the (c) step, the system measures the locations of the respective terminals based on the signals transmitted from the terminals of the workers, and identifies the locations of the SRW terminals of the second workers based on the measured locations.

13. The method of claim 9, wherein with the (c) step, the system judges the locations of the second workers from the database storing the locations of the workers based on the SRW terminals of the second workers.

14. The method of claim 9, wherein with the (c) step, the system measures the locations of the respective terminals based on the signals transmitted from the terminals of the workers, and identifies the locations of the SRW terminals of the second workers based on the measured locations.

15. The method of claim 10, wherein with the (c) step, the system judges the locations of the second workers from the database storing the locations of the workers based on the SRW terminals of the second workers.

16. The method of claim 10, wherein with the (c) step, the system measures the locations of the respective terminals based on the signals transmitted from the terminals of the workers, and identifies the locations of the SRW terminals of the second workers based on the measured locations.

17. A method of notifying of an abnormality of a facility with a short-range wireless (SRW) communication system in a production line for automatically conducting a process of manufacturing semiconductors or TFT-LCDs, the SRW communication system being connected to facility controllers installed at respective facilities in the production line and to a plurality of SRW access points arranged at predetermined locations in the production line, the SRW access points communicating with a plurality of SRW terminals given to respective workers in accordance with a SRW communication protocol to effect a signal transmission with each other, the method comprising the steps of:
(a) upon receipt of facility abnormality information from any of facility controllers with a warning code for a generated error and facility identification information, extracting a person in charge that is capable of coping with the warning code from the warning database that stores the persons in charge for the respective warning codes of the facilities;
(b) identifying the location of the terminal of the extracted person in charge; and
(c) transmitting a warning message corresponding to the warning code to the SRW access point where the terminal of the person in charge is located, and to the terminal of the person in charge.

18. The method of claim 17, wherein with the (a) step, the extracting of the person in charge that is capable of coping with the warning code is done only when the warning code contained in the facility abnormality information is established to notify of the facility abnormality.

19. The method of claim 18, wherein with the (b) step, the location of the terminal of the person in charge is judged based on signals transmitted to the respective SRW access points, and with the (c) step, the person in charge placed closest to the abnormal facility is selected and the warning message corresponding to the warning code is transmitted to the SRW access point where the selected person in charge is located.
